(19) United States
(12) Patent Application Publication
(10) Pub. No.: US 2009/0015132 A1
(43) Pub. Date: Jan. 15, 2009

(54) LEADING MEANS OF ELECTRODE LEADS OF FIELD EMISSION DISPLAY

(76) Inventors: Kuei-Wen CHENG, Guanyin Township (TW); Cheng-Chieh Kao, Guanyin Township (TW); Kuo-Hua Chen, Guanyin Township (TW)

Correspondence Address: HDSL, P.O. BOX 220746, CHANTILLY, VA, 20153-0746, US

(21) Appl. No.: 11/775,479

(22) Filed: Jul. 10, 2007

(51) Int. Cl. H01J 1/62; H01J 17/49

(52) U.S. Cl. 313/495

(57) ABSTRACT

A leading means of electrode leads of a field emission display includes a cathode plate, an anode plate and a package side frame. The cathode plate is combined with the anode plate correspondingly. The cathode plate has a cathode substrate. The cathode substrate is provided thereon with a cathode conductive layer. The anode plate has an anode substrate. The anode substrate is provided with an anode conductive layer thereon. Further, the package side frame is provided between the cathode substrate and the anode substrate. A lead plate extends from one side of the package side frame. Both end faces of the lead plate are provided with a plurality of electrode leads, and a conductive layer is provided between the electrode leads and the cathode/anode substrate to electrically connect with the cathode/anode conducting layer, respectively. The extending lead plate electrically guides the electricity of the cathode conductive layer and the anode conductive layer to the outside, thereby connecting to other power supply.

### BACKGROUND OF THE INVENTION

1. Field of the Invention

The present invention relates to a field emission display, and in particular to a leads arrangement of a field emission display having a package side frame.

2. Description of Prior Art

In recent years, since carbon nanotube has an excellent efficiency of generating electrons, it is widely applied to a cathode electron-emitter in a field emission flat panel display. In comparison with other types of flat panel displays, the filed emission flat panel display has a better brightness, a wider viewing angle, low energy consumption and rapid response, so that it has become more and more important and well-developed.

The most common structure of a filed emission flat panel display is constituted of a cathode plate and an anode plate. The cathode plate and the anode plate have a cathode substrate and an anode substrate respectively. A package side frame is provided between the cathode substrate and the anode substrate to block a vacuum region formed therein. The cooperation of an electric field generated in the internal vacuum region provides a space and power for accelerating free electrons ionized by the carbon nanotube. Finally, the free electrons collide with a fluorescent layer provided on the anode plate to generate a light.

In the above-mentioned structure of the field emission flat panel displayer, in order to electrically connect conductive layers on the cathode substrate and the anode substrate in the vacuum region to an external power supply, there are two conventional common ways. One way is to lay electrode leads on the cathode substrate and the anode substrate. When the cathode substrate and the anode substrate are connected correspondingly, they are deviated from each other so that the electrode leads provided on the cathode substrate can be exposed to the outside of the vacuum region, thereby forming a connecting region of the electrode leads for connecting to the external power supply. However, this way may reduce the efficiency of utilizing the plate material, that is, the ratio of the efficient displaying region to the whole area of the plate material is reduced. As a result, in order to generate an additional connecting region, the cathode plate and the anode plate may be asymmetrical to each other after connection, and thus it is necessary to perform a cutting process according to the demands for different sizes to assure the square shape of the panel. This causes the waste of material and thus becomes a drawback thereof.

Another way is to provide on the panel with electrode leads made of a solid metal. The leads are drawn from the interior of the vacuum region to connect with the outside and the external power supply. Although the manufacturing procedure of this solution is simpler without providing an additional connecting region and thus improves the waste of material occurred in the previous method, the diameter of the electrode lead made of a solid metal is thicker than that formed by a general screen printing. Therefore, it is unsuitable for arranging a plurality of sets of electrode leads to form a high-definition structure. Furthermore, when the electrode leads made of a solid metal pass through the package structure between the cathode substrate and the anode substrate, the difference between the materials may affect the tight connection with the substrate and thus form tiny seams, causing the leakage of air and affecting the internal vacuum environment. Therefore, in view of the drawbacks of the above-mentioned conventional art, it is important and necessary to find a better way to overcome these problems.

### SUMMARY OF THE INVENTION

In view of the above drawbacks, the present invention is to provide a leading means of electrode leads of a field emission display, which is used to lead the internal electrode to the outside. By laying electrode leads on a side frame serving as a package structure to electrically connect with the internal cathode or anode electrode layer, and extending a lead plate outwardly from the side frame to lead the electrode to the outside, it is convenient to connect with an external power supply and keep the square shape of the cathode/anode substrate.

The present invention provides a leading means of electrode leads of a field emission display, which includes a cathode plate, an anode plate and a package side frame. The cathode plate is combined with the anode plate correspondingly. The cathode plate has a cathode substrate. The cathode substrate is provided thereon with a cathode conductive layer. The anode plate has an anode substrate. The anode substrate is provided with an anode conductive layer thereon. Further, the package side frame is provided between the cathode substrate and the anode substrate. A lead plate extends from one side of the package side frame. Both end faces of the lead plate are provided with a plurality of electrode leads, and a conductive layer is provided between the electrode leads and the cathode/anode substrate to electrically connect with the cathode/anode conducting layer, respectively. The extending lead plate electrically guides the cathode conductive layer and the anode conductive layer to the outside, thereby connecting to other power supply.

### BRIEF DESCRIPTION OF THE DRAWINGS

FIG. 1 is a front view showing a cathode plate and an anode plate of the present invention;

FIG. 2 is an exploded cross-sectional view showing the structure of the present invention taken along the line 2-2 in FIG. 1;

FIG. 3 is an exploded cross-sectional view showing the package side frame of the present invention taken along the line 3-3 in FIG. 1; and

FIG. 4 is a top view showing the structure of another embodiment of the present invention.

### DETAILED DESCRIPTION OF THE INVENTION

The technical contents of the present invention will be explained with reference to the accompanying drawings.

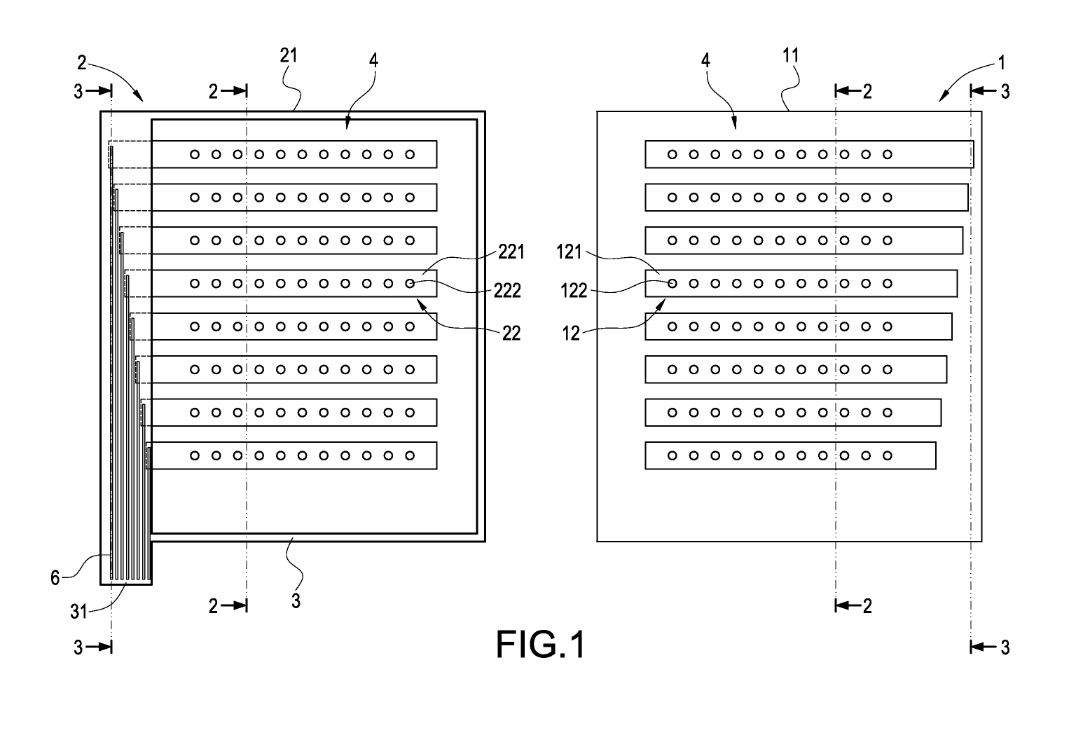

With reference to FIG. 1, it is a front view showing a cathode plate and an anode plate of the present invention. As shown in this figure, the field emission display of the present invention includes a cathode plate 1, an anode plate 2 and a package side frame 3. The cathode plate 1 is combined with the anode plate 2 correspondingly. The cathode plate 1 has a cathode substrate 11. The cathode substrate 11 is provided with a plurality of cathode units 12 thereon. Each cathode unit 12 includes a cathode electrode layer 121 that is provided on the cathode substrate 11. The cathode electrode layer 121 is provided thereon with a plurality of cathode electrode-emitters 122. Each cathode electron-emitter 122 is arranged at an interval for releasing free electrons. The anode plate 2 has an anode substrate 21. The anode substrate 21 is provided with an anode unit 22 thereon. The anode unit 22 includes an anode conductive layer 221 and a plurality of fluorescent layers 222. The anode conductive layer 221 is provided on the anode substrate 21. The plurality of fluorescent layers 221 is provided on the anode conductive layer 221 at intervals. The position of each fluorescent layer 222 exactly corresponds to that of each cathode electron-emitter 122.

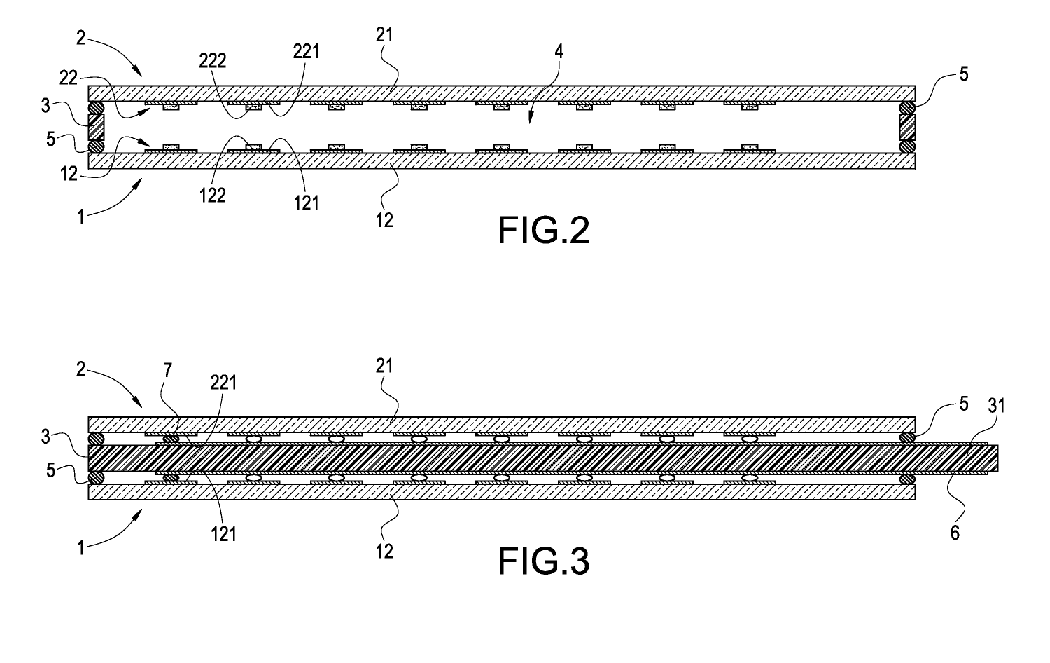

With reference to FIGS. 1 and 2, FIG. 2 is a cross-sectional view showing the structure of the present invention taken along the line 2-2 in FIG. 1. The package side frame is provided on peripheral edges of the cathode substrate 11 and the anode substrate 21 to act as a supporting structure between the cathode plate 1 and the anode plate 2. A vacuum package region 4 is formed between the cathode plate 1 and the anode plate 2, so that the free electrons released by the cathode plate 1 have a sufficient space for movement. The connecting surface between the lower end face of the package side frame 3 and the cathode plate 1 and the connecting surface between the upper end face of the package side frame 3 and the anode plate 2 are coated with a package layer 5 respectively. The package layer 5 is glass glue for fixing the position of the package side frame 3 with respect to the cathode plate 1 and the anode plate 2, as shown in the front view of FIG. 2. A lead plate 31 extends outwardly from one side of the package side frame 3. As shown in the cross-sectional view of the package side frame of FIG. 3 taken along the line 3-3 in FIG. 1, the lead plate 31 is formed into an elongate plate. The upper and lower plate surfaces of the lead plate 31 are provided with at least one electrode lead 6 respectively. In the present embodiment, a plurality of electrode leads 6 is provided. The electrode leads 6 extend inwardly from the lead plate 31 to the same side of the package side frame 3. Further, a conductive layer 7 is provided between the electrode leads 6 and the conductive layer 121 of the cathode plate 1 and the electrode leads and the conductive layer 221 of the anode plate 2, respectively. As shown in the cross-sectional view of the package side frame of FIG. 3, the conductive layer 7 is made of conductive glass glue containing gold, silver or indium tin oxide, so that these electrode leads 6 are electrically connected with the cathode conductive layer 121 and the anode conductive layer 221. Via this arrangement, the electrode layers 121, 222 of the cathode plate 1 and the anode plate 2 within the vacuum package region 4 can be electrically connected with each other. Via the conductive layer 7 and the plurality of electrode leads 6 extending from one side of the package side frame 3 to the lead plate 31, the electrode layers 121, 222 within the cathode plate 1 and the anode plate 2 can be extended to the outside of the vacuum package region 4. With this arrangement, an external driving power source can be electrically connected with the electrode layers 121, 222 in the vacuum package region 4 via the extending electrode leads 6.

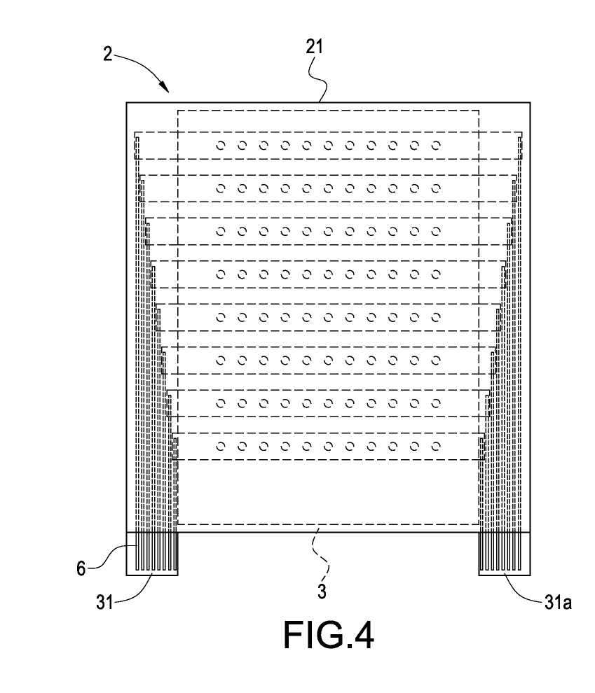

With reference to FIG. 4, it is a top view showing the structure of another embodiment of the present invention. As shown in this figure, in addition to extend a lead plate 31 from one side of the package side frame 3, lead plates 31 and 31a can be extended outwardly from both sides of the package side frame 3 respectively. The lower plate surface of the lead plate 31 is provided with at least one electrode lead 6. In the present embodiment, a plurality of electrode leads 6 is provided. Each electrode lead 6 is electrically connected with the cathode conductive layer 121 in the package region 4 via the conductive layer 7. Further, the upper plate surface of the lead plate 31a is provided thereon with at least one electrode lead 6. In the present embodiment, a plurality of electrode leads 6 is provided. Each electrode lead 6 is electrically connected with the anode conductive layer 221 in the package region 4 via the conductive layer 7. Via the lead plates 31 and 31a extending from both sides of the package side frame 3, the electricity within the package region 4 can be guided to the outside, thereby providing an electrical connection between an external driving power supply and the interior of the package region.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A leading means of electrode leads of a field emission display, comprising:
a cathode plate having a cathode substrate, the cathode substrate being provided thereon with a cathode conductive layer;
an anode plate combined with the cathode plate correspondingly, the anode plate having an anode substrate, the anode substrate being provided thereon with an anode conductive layer;
a package side frame provided on peripheral edges of the cathode substrate and the anode substrate for supporting and sealing a vacuum region formed between the cathode substrate and the anode substrate, a lead plate extending from one side of the package side frame, one end face of the lead plate being provided thereon with a plurality of electrode leads, the electrode leads extending from the lead plate to the side frame on the same side; and
a conductive layer connected between the electrode leads and the cathode conductive layer or the anode conductive layer, thereby forming an electrical connection therebetween.

2. The leading means of electrode leads of a field emission display according to claim 1, wherein the conductive layer is constituted of conductive glass glue.

3. The leading means of electrode leads of a field emission display according to claim 2, wherein the conductive glass glue is comprised of gold, silver or indium tin oxide.

4. The leading means of electrode leads of a field emission display according to claim 1, wherein lead plates extend from both sides of the package side frame, one end face of each lead plate is provided thereon with a plurality of electrode leads, the electrode leads extend from the lead plate to the side frame on the same side, a conductive layer is provided respectively between each electrode lead and the cathode conductive layer and the anode conductive layer, thereby forming an electrical connection between each electrode lead and the cathode conductive layer and the anode conductive layer.

5. The leading means of electrode leads of a field emission display according to claim 1, wherein a package layer is provided between the package side frame and the cathode substrate and the anode substrate for fixing a position of the package side frame with respect to the cathode substrate and the anode substrate.
